(19) United States
(12) Patent Application Publication
(10) Pub. No.: US 2009/0289047 A1
(43) Pub. Date: Nov. 26, 2009

(54) NIGHT LIGHT ASSEMBLY

(76) Inventor: Mingjen HISAO, Humen Town (CN)

Correspondence Address: Dr. BANGER SHIA, 102 Lindencrest Ct., Sugar Land, TX, 77479-5201, US

(21) Appl. No.: 12/126,369

(22) Filed: May 23, 2008

(51) Int. Cl. H05B 1/00

(52) U.S. Cl. 219/220

(57) ABSTRACT

A night light includes a case, a bottle filled with liquid, an illuminating unit, a heating device, and a power cord unit. The case comprises a main portion and an extending portion. The main portion has a first compartment to accommodate the illuminating unit. The top of the main portion is formed with a first platform to receive the bottle. The extending portion has a second compartment. The heating device is located on a second platform provided at the top of the extending portion. The power cord unit comprises a first power cord connected to a holder of the illuminating unit and a second power cord connected to a heating member of the heating device. When the illuminating unit is conducted, the bottle filled with liquid is to form a water globe night light, and the heating device is conducted to smoke fragrance material.

### BACKGROUND OF THE INVENTION

1. Field of the Invention

The present invention relates to a night light assembly, and more particularly to a night light having a heating device that is applied to smoke scent wax or essence.

2. Description of the Prior Art

A conventional water globe night light comprises a decoration, a liquid radiating portion, a case, a light bulb, a holder, a fixture, a bottom board, and a power cord. The holder is mounted on the bottom board with the fixture so as to hold the light bulb located in the case. The liquid radiating portion is disposed on the case. When the power cord is conducted, the light bulb emits soft beam through the liquid radiating portion to provide comfortable atmosphere, but it fails to improve the smell of the environment.

### SUMMARY OF THE INVENTION

The purpose of the present invention is to provide a night light having a heating device to improve the smell of the environment.

To achieve the purpose of the present invention, there is provided a night light assembly, comprising:

a case comprising a main portion and an extending portion extending from one side of the main portion, the main portion comprising a first compartment and a first platform at the top of the main portion, the first platform having a first opening interconnecting with the first compartment, the extending portion comprising a second compartment and a second platform at the top of the extending portion, the second platform having a second opening interconnecting with the second compartment;

a bottle filled with liquid, the bottle being located on the first opening of the first platform;

an illuminating unit located in the first compartment, the illuminating unit comprising a light bulb and a holder to hold the light bulb;

a heating device located on the second platform, the heating device comprising a metallic plate and a heating member for heating the metallic plate, the metallic plate being located on top of the second opening; and

a power cord unit comprising a first power cord and a second power cord, the first power cord being electrically connected to the holder, the second power cord being electrically connected to the heating member.

Preferably, a separate portion is provided between the first compartment and the second compartment.

Preferably, the base is provided with a bottom board to seal the first compartment and the second compartment.

Preferably, a stand is provided under the metallic plate and the stand has a through hole at the bottom of the stand, the heating member being located in the stand, a bolt inserting through the bottom board and the through hole to engage with the heating member, the bolt being fastened with a nut inserting through a lower end of the bolt.

Preferably, the bottom board has a hole corresponding in position to the first compartment so as to replace the illuminating unit, and the hole is covered by a lid.

Preferably, a fixture is provided on the hole, and the holder is secured to the fixture.

Preferably, the holder is secured to the fixture with a resilient clamping member.

Preferably, the first power cord and the second power cord are connected with a pair of normally closed terminals to form an externally connected power cord.

Preferably, the bottle is provided with a decorating member.

Preferably, the heating member is a PTC (Positive Temperature Coefficient) ceramic heater.

It is one object of the present invention to provide a night light assembly, which provides the illuminating unit installed on the main portion of the case so as to radiate soft lamplight through the bottle filled with liquid.

It is another object of the present invention to provide a night light assembly, which provides the heating device installed on the extending portion of the case to heat fragrance materials so as to improve the environment.

### BRIEF DESCRIPTION OF THE DRAWINGS

FIG. 1 is an exploded view of a preferred embodiment of the present invention, partially sectioned; and

FIG. 2 is an assembled view of the preferred embodiment of the present invention.

### DETAILED DESCRIPTION OF THE INVENTION

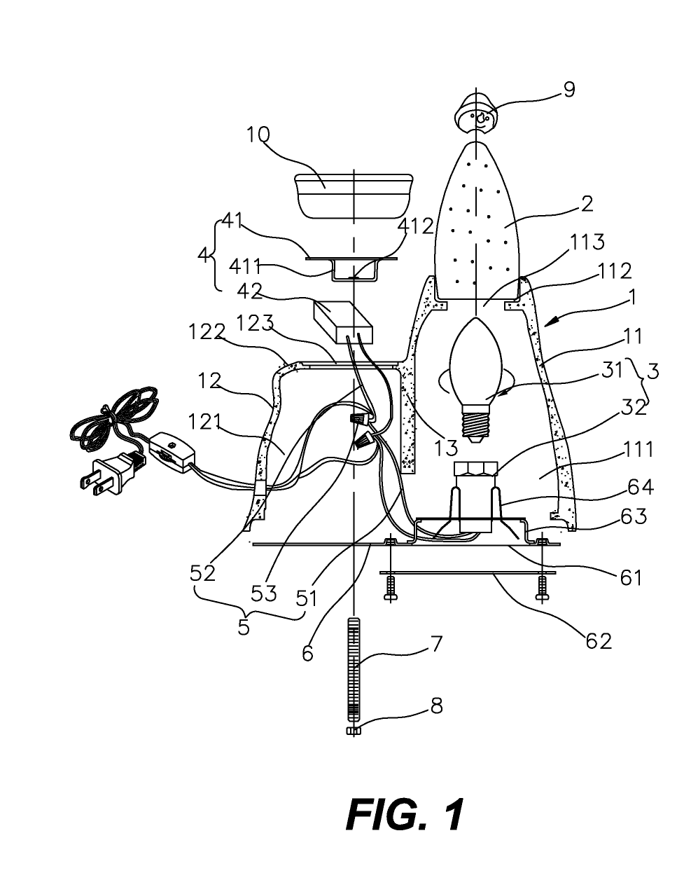

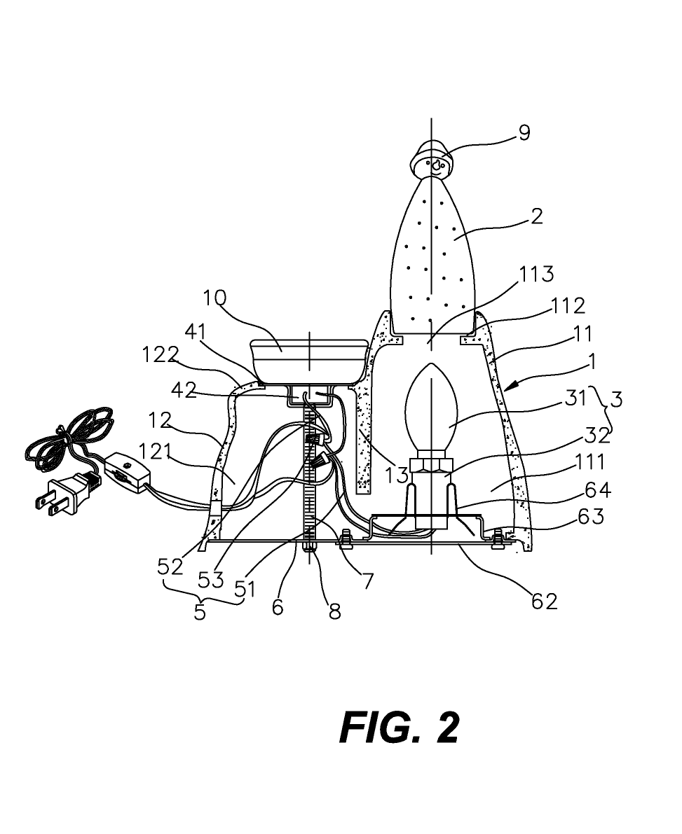

As shown in FIGS. 1 and 2, a night light assembly in accordance with a preferred embodiment of the present invention comprises a case (1), a bottle (2), an illuminating unit (3), a heating device (4), and a power cord unit (5).

The case (1) is made of an insulating material (such as gypsum), and comprises a main portion (11) and an extending portion (12) extending from one side of the main portion (11). The main portion (11) comprises a first compartment (111) and a first platform (112) at the top of the main portion (11). The first platform (112) has a first opening (113) interconnecting with the first compartment (111). The extending portion (12) comprises a second compartment (121) and a second platform (122) at the top of the extending portion (12). The second platform (122) has a second opening (123) interconnecting with the second compartment (121). The first compartment (111) and the second compartment (121) are interconnected with each other, and a separate portion (123) is provided between the first compartment (111) and the second compartment (121), preventing the parts in both compartments from disordering. The bottom of the main portion (11) is at the same level with the bottom of the extending portion (12). A bottom board (6) is adapted to seal the first compartment (11) and the second compartment (12). The bottom board (6) has a hole (61) corresponding in position to the first compartment (11) so as to replace the corresponding parts. The hole (61) is covered by a lid (62). The lid (62) is secured to the bottom board (6) by means of screws. A fixture (63) is provided on the hole (61).

The bottle (2) is filled with liquid and located on the first opening (113) of the first platform (112). A decorating member (9) is provided on the top of the bottle (2) to beautify the bottle (2).

The illuminating unit (3) is located in the first compartment (111), and comprises a light bulb (31) and a holder (32) to hold the light bulb (31). The holder (32) is secured to the fixture (63) with a resilient clamping member (64) so that the user is able to install or replace the illuminating unit (3) through the hole (61).

The heating device (4) is located on the second platform (122), and comprises a metallic plate (41) and a heating member (42) for heating the metallic plate (41). The metallic plate (41) is located on top of the second opening (123). A stand (411) is provided under the metallic plate (41). The stand (411) has a through hole (412) at the bottom of the stand (411). The heating member (42) is a PTC (Positive Temperature Coefficient) ceramic heater, and is located in the stand (412). A bolt (7) is inserted through the bottom board (6) and the through hole (412) to engage with the heating member (42). The bolt (7) is fastened with a nut (8) inserting through a lower end of the bolt (7) so that the bottom board (6) is secured to the case (1).

The power cord unit (5) comprises a first power cord (51) and a second power cord (52). The first power cord (51) is electrically connected to the holder (32), and the second power cord (52) is electrically connected to the heating member (42). The first power cord (51) and the second power cord (52) are connected with a pair of normally closed terminals (53) to form an externally connected power cord.

To operate the present invention, the light bulb (31) of the illuminating unit (3) is conducted by the first power cord (51) to radiate soft lamplight through the liquid in the bottle (2), forming a water globe night light to provide conformable and romantic atmosphere. Furthermore, the heating member (42) of the heating device (4) is conducted by the second power cord (52) to heat the metallic plate (41). A conductive bowl (10) filled with a fragrance material (such as scent wax or essence) is provided on the metallic plate (41). By heating the metallic plate (41), the fragrance material in the bowl (10) spreads its fragrance. The metallic plate (41) of the heating device (4) may heat other materials such as coffee.

The purpose of the present invention is to combine the illuminating unit and the heating device installed on the main portion and the extending portion of the case so as to provide comfortable atmosphere and to improve the environment.

Although the present invention has been shown and described with respect to the preferred embodiment, it will be understood by those skilled in the art that various changes and modifications may be made without departing from the spirit and scope of the invention as defined in the following claims.

What is claimed is:

1. A night light assembly, comprising:
a case comprising a main portion and an extending portion extending from one side of the main portion, the main portion comprising a first compartment and a first platform at the top of the main portion, the first platform having a first opening interconnecting with the first compartment, the extending portion comprising a second compartment and a second platform at the top of the extending portion, the second platform having a second opening interconnecting with the second compartment;
a bottle filled with liquid, the bottle being located on the first opening of the first platform;
an illuminating unit located in the first compartment, the illuminating unit comprising a light bulb and a holder to hold the light bulb;
a heating device located on the second platform, the heating device comprising a metallic plate and a heating member for heating the metallic plate, the metallic plate being located on top of the second opening; and
a power cord unit comprising a first power cord and a second power cord, the first power cord being electrically connected to the holder, the second power cord being electrically connected to the heating member.

2. The night light assembly as claimed in claim 1, wherein a separate portion is provided between the first compartment and the second compartment.

3. The night light assembly as claimed in claim 2, wherein the base is provided with a bottom board to seal the first compartment and the second compartment.

4. The night light assembly as claimed in claim 3, wherein a stand is provided under the metallic plate and the stand has a through hole at the bottom of the stand, the heating member being located in the stand, a bolt inserting through the bottom board and the through hole to engage with the heating member, the bolt being fastened with a nut inserting through a lower end of the bolt.

5. The night light assembly as claimed in claim 4, wherein the bottom board has a hole corresponding in position to the first compartment so as to replace the illuminating unit, and the hole is covered by a lid.

6. The night light assembly as claimed in claim 5, wherein a fixture is provided on the hole, and the holder is secured to the fixture.

7. The night light assembly as claimed in claim 6, wherein the holder is secured to the fixture with a resilient clamping member.

8. The night light assembly as claimed in claim 1, wherein the first power cord and the second power cord are connected with a pair of normally closed terminals to form an externally connected power cord.

9. The night light assembly as claimed in claim 1, wherein the bottle is provided with a decorating member.

10. The night light assembly as claimed in claim 1, wherein the heating member is a PTC (Positive Temperature Coefficient) ceramic heater.
